(19) United States
(12) Patent Application Publication
(10) Pub. No.: US 2025/0378657 A1
(43) Pub. Date: Dec. 11, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HIROKI WATABE, Tokyo (JP)

(21) Appl. No.: 19/227,710

(22) Filed: Jun. 4, 2025

(30) Foreign Application Priority Data
Jun. 11, 2024 (JP) 2024-094168

(51) Int. Cl. G06T 19/00; G02B 27/01

(52) U.S. Cl. CPC G06T 19/006; G02B 27/017

(57) ABSTRACT

An image processing apparatus controls a display device wearable on a head of a user and includes: an obtainment unit configured to obtain a reality image which is an image captured of an actual space around the user and a saving unit configured to save the reality image obtained by the obtainment unit, in a state when the display device is being worn by the user.

### CROSS-REFERENCE TO PRIORITY APPLICATION

This application claims the benefit of Japanese Patent Application No. 2024-094168, filed Jun. 11, 2024, which is hereby incorporated by reference herein in its entirety.

### BACKGROUND

### Field of the Technology

The present disclosure relates to an image processing system including a head-mounted display.

### Description of the Related Art

Head-mounted displays (HMDs) are used as a form of a display device for viewing a video combining a virtual world and reality. An HMD is a display device wearable on the head of a user and displays a video of a virtual world mainly formed by CG according to the position or attitude of the user to provide the user with experience as if the user has entered an “unreal” space.

Incidentally, a camera may be installed at a fixed point to record a video for crime prevention purposes. Also, as a technique related to HMD recording, Japanese Patent Laid-Open No. 2017-146578 (Patent Literature 1) proposes a technique for recording a virtual reality (VR) video displayed on an HMD.

### SUMMARY

An image processing apparatus of the present disclosure controls a display device wearable on a head of a user and includes an obtainment unit configured to obtain a reality image which is an image captured of an actual space around the user and a saving unit configured to save the reality image obtained by the obtainment unit in a state where the display device is being worn by the user.

Further features of the present disclosure will become apparent from the following description of exemplary embodiments with reference to the attached drawings.

### BRIEF DESCRIPTION OF THE DRAWINGS

FIG. 1 is a diagram showing an overall configuration of an image processing system including an HMD;

FIG. 2 is a diagram showing an overview of an internal configuration of the HMD;

FIG. 3 is a diagram showing a hardware configuration of an image processing apparatus;

FIG. 4 is a diagram showing a functional configuration of a first embodiment;

FIG. 5 is a flowchart showing the overall flow of processing in the first embodiment;

FIG. 6 is a flowchart showing the flow of image saving processing;

FIG. 7 is a diagram showing a functional configuration of a second embodiment;

FIG. 8 is a flowchart showing the overall flow of processing in the second embodiment;

FIG. 9 is a diagram showing a functional configuration of a third embodiment;

FIG. 10 is a flowchart showing the overall flow of processing in the third embodiment;

FIG. 11 is a diagram showing a functional configuration of a fourth embodiment;

FIG. 12 is a flowchart showing the overall flow of processing in the fourth embodiment;

FIG. 13 is a diagram showing a functional configuration of a fifth embodiment;

FIG. 14 is a flowchart showing the flow of image saving processing in the fifth embodiment;

FIG. 15 is a diagram showing a functional configuration of a sixth embodiment;

FIG. 16 is a flowchart showing the overall flow of processing in the sixth embodiment;

FIG. 17 is a flowchart showing the flow of second image saving processing in the sixth embodiment;

FIGS. 18A to 18F are diagrams illustrating a save image in the sixth embodiment;

FIG. 19 is a diagram showing a functional configuration of a seventh embodiment;

FIG. 20 is a flowchart showing the overall flow of processing in the seventh embodiment; and

FIG. 21 is a flowchart showing the flow of image saving processing in a modification of the seventh embodiment.

### DESCRIPTION OF THE EMBODIMENTS

Hereafter, with reference to the attached drawings, the present disclosure explains some example embodiments in detail. Configurations shown in the following embodiments are merely exemplary and some embodiments of the present disclosure are not limited to the configurations shown schematically.

### First Embodiment

In recent years, people have more and more opportunities to experience HMD videos at such places as an event venue or a storefront. However, both eyes of a user are covered while they are viewing a video with an HMD, which hinders the user checking the situation of their surroundings and makes them defenseless. This makes it difficult for a user to enjoy videos with an easy mind at places with large crowds, such as event venues as described above.

What the technique in Patent Literature 1 records is a video displayed on an HMD and is not intended to ensure safety for the user using the HMD.

In a first embodiment, in a state where a head-mounted display (HMD) is being worn by a user, an image processing apparatus saves reality images which are images captured of the real space surrounding the user.

### (Configuration of an Image Processing System)

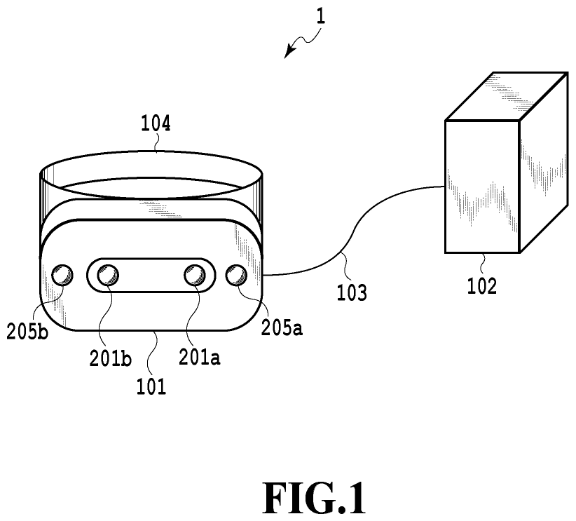

FIG. 1 shows the configuration of an HMD system 1 as an example of an image processing system including an image processing apparatus of the present disclosure. The HMD system 1 includes an HMD 101 and an image processing apparatus 102 which are communicatively connected via a transmission channel 103 and communicate image data, control signals, and the like. The transmission channel 103 includes a video signal line such as an HDMI (registered trademark) cable and a data signal line such as a USB cable. Also, to receive inputs from a user, an input device such as a controller or a keyboard is communicatively connected to the image processing apparatus 102. The modes of the communicative connection between the HMD 101 and the image processing apparatus 102 and the communicative connection between the image processing apparatus 102 and the input device may be wired connection accomplished by a USB cable or the like or wireless connection accomplished by Bluetooth (registered trademark) or the like.

The HMD 101 is worn on the head of a user and allows the left eye and the right eye of the user to view (magnified virtual images of) a display image for the right eye and a display image for the left eye, respectively. Note that the HMD 101 shown in FIG. 1 is, as an example, a goggle-type headset worn on the head of a user using a band 104, but the present disclosure is not limited to this and may be in the shape of sunglasses or other shapes. Also, as shown in FIG. 1, the HMD of the present embodiment has stereo cameras 201a, 201b and stereo cameras 205a, 205b, each set being disposed at right and left positions with a predetermined space therebetween. Although a total of four cameras are provided in FIG. 1, it is to be noted that the number of cameras is not limited to this as long as at least one camera is provided. The positions where the cameras are installed are also not limited to those shown in the example in FIG. 1.

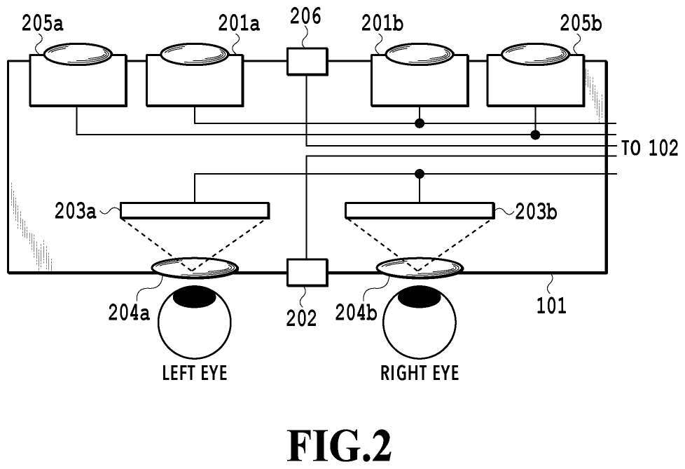

FIG. 2 is a diagram showing an internal configuration of the HMD 101. The HMD 101 includes the plurality of cameras 201a, 201b, 205a, 205b, and a proximity sensor 202, displays 203a, 203b, eyepieces 204a, 204b, a distance sensor 206, and the like. The HMD 101 may further include an inertial measurement unit (IMU) for implementing position tracking, a speaker that outputs audio, a microphone that receives audio input, a vibrator that produces vibration, an LED lamp that indicates the status of the apparatus, and the like.

As shown in FIG. 2, the eyepiece 204a, the display 203a, and the camera 201a are arranged facing the left eye of the user in this order from closest to farthest relative to the eye. The eyepiece 204b, the display 203b, and the camera 201b are arranged facing the right eye of the user in this order from closest to farthest relative to eye.

The cameras 201a, 201b are RGB cameras and capture images of the actual space around the user. The images captured by the cameras 201a, 201b are sequentially transmitted to the image processing apparatus 102 and used to generate display images. The cameras 201a, 201b are what is called stereo cameras, where two cameras are disposed at left and right positions with a known interspace between them.

The cameras 205a, 205b are cameras for positioning (position tracking) and capture images of the actual space around the user. The images captured by the cameras 205a, 205b are sequentially transmitted to the image processing apparatus 102 and used for, e.g., self-position estimation and generation of an environment map using visual simultaneous localization and mapping (visual SLAM). The cameras 205a, 205b are also what is called stereo cameras, where two cameras are disposed at left and right positions with a known interspace between them. The cameras 205a, 205b are provided at positions more towards the left and right end portions of a casing of the HMD 101 than the RGB cameras 201a, 201b in the example shown in FIG. 1, but their positions are not limited to this. For example, the cameras 205a, 205b may be disposed toward the lower side or the upper side. Also, in addition to the cameras 205a, 205b, cameras capable of capturing images of the rear side and the left and right sides of the user may be provided. Also, an omnidirectional camera may be achieved which is capable of generating a 360°-range image through image processing performed on images captured by a plurality of cameras.

The cameras 201a, 201b used for generation of display images are hereinafter referred to as display image generation cameras. Also, the plurality of display image generation cameras 201a, 201b are denoted by reference numeral 201 unless they need to be distinguished from each other. Also, the cameras 205a, 205b for positioning (position tracking) are hereinafter referred to as positioning cameras, and the plurality of positioning cameras 205a, 205b are denoted by reference numeral 205 unless they need to be distinguished from each other.

Timings for the display image generation cameras 201 and the positioning cameras 205 to start and end image capture are controlled by a CPU 301 of the image processing apparatus 102. For example, the timing for the positioning cameras 205 to start image capture may be the timing at which the HMD 101 is activated, the timing at which the HMD 101 is worn on the head of a user, or the timing at which the user or an operator inputs an instruction to start positioning processing. The timing for the positioning cameras 205 to end image capture may be the timing at which the user removes the HMD 101 from their head or the timing at which the user or an operator inputs an instruction to end the positioning processing. Similarly, the timing for the display image generation cameras 201 to start image capture may be the timing at which the HMD 101 is activated, the timing at which the HMD 101 is worn on the head of a user, or the timing at which the user or an operator inputs an instruction to start display processing. The timing for the display image generation cameras 201 to end image capture may be the timing at which the user removes the HMD 101 from their head or the timing at which the user or an operator inputs an instruction to end the display processing.

Being used to generate display images, the display image generation cameras 201 can have a higher resolution than the positioning cameras 205 and can capture color images. By contrast, the positioning cameras 205 do not prioritize image quality and have a wider angle of view than the display image generation cameras 201. Also, to lower the processing load on the CPU, the positioning cameras 205 may have a low frame rate, have a low resolution, and capture monochrome images.

Also, although the present embodiment shows an example configuration where the display image generation cameras 201 and the positioning cameras 205 are both provided, the display image generation cameras 201 may be used as the positioning cameras 205 as well. Specifically, reality images captured by the display image generation cameras 201 may be used not only for generation of display images, but also for self-position estimation and generation of an environment map. The self-position is expressed by, for example, 6 degrees of freedom (DoF). Specifically, the self-position is expressed by forward/back, up/down, left/right, pitch, yaw, and roll. Note that the method for the self-position estimation is not limited to visual SLAM using a plurality of cameras, and may use the distance sensor 206 such as light detection and ranging (lidar) or an IMU.

The proximity sensor 202 is provided at, e.g., a surface of the casing of the HMD 101 which comes into contact with the head of the user and detects wearing by the user. The proximity sensor 202 outputs a signal indicative of wearing detection in a case where the distance between the head of the user and the proximity sensor 202 is smaller than a predetermined threshold.

The displays 203a, 203b are formed by, for example, display panels such as liquid crystal panels or organic electroluminescent (EL) panels. Further, the eyepieces 204a, 204b are disposed in front of the displays 203a, 203b at positions corresponding to the left and right eyes, respectively. Through these eyepieces 204a, 204b, the user of the HMD 101 can observe magnified virtual images of the display images displayed on the displays 203a, 203b.

The image processing apparatus 102 performs processing to generate a display image for the left eye and a display image for the right eye and display these images on the displays 203a, 203b, respectively, of the HMD 101. In this event, the image processing apparatus 102 can add appropriate parallax between the left-eye display image and the right-eye display image so that the user can perceive depth in the video.

Although the HMD system 1 of the present embodiment is described as having a system configuration where the image processing apparatus 102 and the HMD 101 are separately configured, the HMD system 1 may have an integral HMD system configuration where, for example, the image processing apparatus 102 is included in the HMD 101.

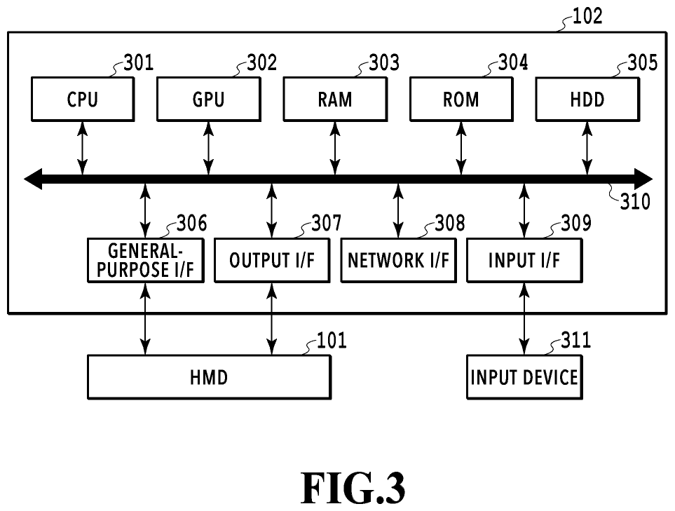

FIG. 3 is a diagram showing an example configuration of the image processing apparatus 102 according to the present disclosure. The image processing apparatus 102 has the CPU 301, a GPU 302, a RAM 303, a ROM 304, an HDD 305, a general-purpose interface (I/F) 306, an output I/F 307, a network I/F 308, and an input I/F 309. These units are connected with one another via a system bus 310.

The CPU 301 performs overall control of the HMD system 1. The CPU 301 is a processor that controls the entire system by reading and executing system programs stored in the ROM 304 or the HDD 305. Also, the CPU 301 implements operations of the present embodiment by reading and executing application programs stored in the ROM 304 or the HDD 305. Although there is one CPU in FIG. 3, there may be a plurality of CPUs.

The GPU 302 is a processor that performs image processing in response to a command from the CPU 301. For example, the GPU 302 performs computer graphics (CG) rendering and generates display images to display on the displays of the HMD 101. The display images may be only CG or may be virtual reality images where CG, which is a virtual object, is superimposed on reality images obtained from the RGB cameras 201 of the HMD 101. A description about display images will be given later. Although there is one GPU in FIG. 3, there may be a plurality of GPUs.

The RAM 303 is a general-purpose RAM and, for example, is used as work memory for storing various kinds of information temporarily while the CPU 301 executes programs. The ROM 304 is a general-purpose ROM and stores, e.g., programs to be executed by the CPU 301 or the GPU 302. The HDD (hard disk drive) 305 is a storage medium (a storage unit) for storing image data, results of various kinds of processing, other data, and various programs executed by the CPU 301 and the GPU 302. Note that the HDD 305 may be a solid-state drive (SSD) or flash memory.

The general-purpose I/F 306 is a serial-bus interface such as USB or IEEE 1394 and connects a peripheral. The general-purpose I/F 306 is also used to obtain images inputted from the RGB cameras 201 and the positioning cameras of the HMD 101 and to obtain signals inputted from the sensors of the HMD 101. The output I/F 307 is an interface such as HDMI or a display port and used to display display images on the displays 203 of the HMD 101 and to output audio to a speaker (not shown).

The network I/F 308 is an interface for communicatively connecting to a LAN or the Internet as controlled by the CPU 301. Through a network, the image processing apparatus 102 can communicatively connect to the HMD system 1 used by other users or communicatively connect to an external content distribution server or the like. The system bus 310 governs the flow of data in the entire image processing apparatus 102. Note that the image processing apparatus 102 may include constituents other than those described above. The input I/F 309 is a serial bus interface such as USB or IEEE 1394 and connects an input device 311 such as a keyboard, a mouse, a touch panel, or a controller.

### (Functional Configuration of the HMD)

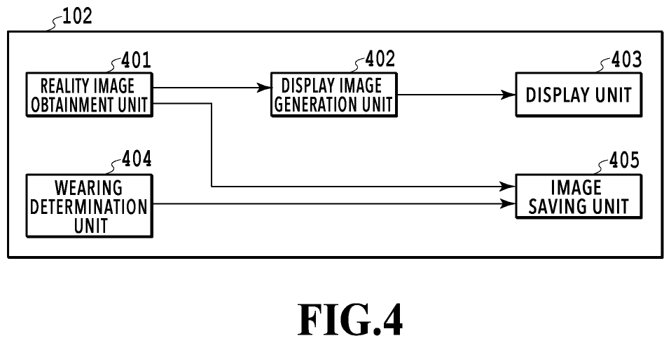

FIG. 4 is a diagram showing a functional configuration of the image processing apparatus 102 of the first embodiment. The image processing apparatus 102 has a reality image obtainment unit 401, a display image generation unit 402, a display unit 403, a wearing determination unit 404, and an image saving unit 405. Program modules corresponding to the respective constituents shown in FIG. 4 are included in an application program. Then, the CPU 301 functions as the constituents shown in FIG. 4 by executing the respective program modules. This applies to the other embodiments described herein as well.

The reality image obtainment unit 401 obtains reality images captured by the image capture units provided to the HMD 101 (the cameras 201, 205). A reality image is an image of an actual space and may be a still image or a moving image. The present embodiment assumes that a reality image is a moving image. Reality images obtained from the display image generation cameras 201 are inputted to the display image generation unit 402. Reality images obtained from the positioning cameras 205 are inputted to the image saving unit 405.

The display image generation unit 402 generates display images to be displayed on the displays 203 of the HMD 101. The display unit 403 outputs the display images generated by the display image generation unit 402 to the HMD 101 to have them displayed on the displays. The display image may be a still image or a moving image, and the present embodiment assumes that the display image is a moving image.

The wearing determination unit 404 determines whether the HMD 101 is being worn by a user. The wearing determination unit 404 determines whether the HMD 101 is being worn by a user based on a signal inputted from the proximity sensor 202. The wearing determination unit 404 determines that the HMD 101 is being worn by a user upon obtainment of a signal from the proximity sensor 202 indicating that wearing has been detected. The wearing determination unit 404 outputs a determination result to the image saving unit 405.

Upon obtainment of a determination result indicating that the HMD 101 is being worn by a user from the wearing determination unit 404, i.e., in a state where a user is wearing the HMD 101, the image saving unit 405 saves the reality images obtained by the reality image obtainment unit 401 to the HDD 305. In the present embodiment, the image saving unit 405 saves the reality images obtained from the positioning cameras 205 to the HDD 305.

### (Processing Executed by the Image Processing Apparatus)

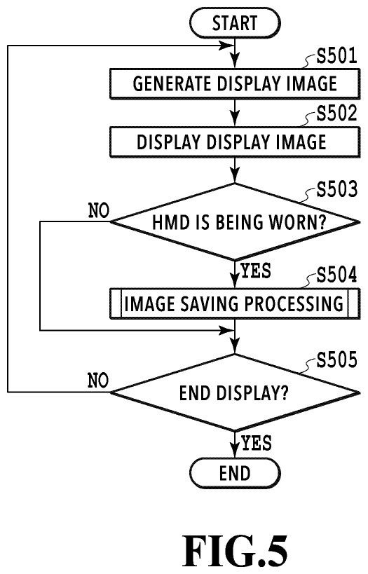

FIG. 5 is a flowchart showing the overall flow of processing in the first embodiment. FIG. 5 is used to describe the overall flow of the processing executed by the image processing apparatus 102. For example, the flowchart shown in FIG. 5 is implemented as follows: the CPU 301 loads a program stored in the HDD 305 into the RAM 303 and executes the program. With reference to FIG. 5, the processing of the first embodiment is described. Note that the letter “S” used in the description of each process means that it is a step in the flowchart. It is assumed here that at the time that the flowchart is started, the positioning cameras 205 and the display image generation cameras 201 provided at the HMD 101 are capturing reality images and sequentially inputting the reality images to the image processing apparatus 102. This applies to the other flowcharts herein.

In S501, the display image generation unit 402 generates display images. Examples of the display images include a virtual reality (VR) video, an augmented reality (AR) video, and a mixed reality (MR) video. A VR video is a video where all the videos formed mainly by computer graphics (CG) are virtual and represent an unreal CG space. An AR video is a video displayed with various pieces of information (such as a virtual object) being added to a reality image in real time. An MR video is an extension of an AR video and is a video displayed with a virtual object or a virtual space which is not actually there being superimposed on the real world to represent a mixed reality space. By using the HMD 101, the user can see these videos from any position or angle that they desire. Note that in a case where images each including a reality image are generated as display images, reality images obtained from the display image generation cameras 201 in FIG. 2 is used. As described earlier, the display image generation unit 402 generates a left-eye display image and a right-eye display image having appropriate parallax.

In S502, the display unit 403 displays the left-eye display image and the right-eye display image generated in S501 respectively on the left-eye display 203a and the right-eye display 203b of the HMD 101.

While the display processing in S501 and S502 is executed, in S503 the wearing determination unit 404 determines whether the HMD 101 is being worn by a user. This determination is made using, for example, the proximity sensor 202 installed on the HMD 101. Note that the determination as to whether the HMD 101 is being worn is not limited to the method using the proximity sensor 202. If a signal indicating that wearing has been detected is obtained from the proximity sensor 202, the processing proceeds to S504. If a signal indicating that wearing has been detected is not obtained from the proximity sensor 202, the processing proceeds to S505.

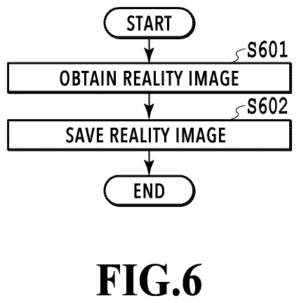

In S504, the image saving unit 405 performs image saving processing. Details of this processing will be described later (FIG. 6).

In S505, the image saving unit 405 determines whether to end the display processing. If it is determined not to end the display processing, the processing proceeds back to S501. If it is determined to end the display processing because, e.g., a user has inputted a stop instruction, the processing in this flowchart ends.

### (Details of the Image Saving Processing)

FIG. 6 is a flowchart showing the flow of the image saving processing in S504 in the first embodiment. FIG. 6 is used to describe the flow of the image saving processing of the first embodiment executed by the CPU 301 of the image processing apparatus 102.

In S601, the reality image obtainment unit 401 obtains reality images inputted from the positioning cameras 205 connected to the HMD 101.

In S602, the image saving unit 405 saves the reality images obtained in S601 to the HDD 305.

As thus described, with the processing in the first embodiment, images of the real world captured while the HMD 101 is being worn by a user can be saved. Specifically, images of the actual space surrounding the user who is wearing the HMD 101 and is viewing, e.g., a video of a virtual space (referred to as a VR video) can be saved (recorded). This allows the user to later check the situation of the real world while the user was viewing a VR video and thus to be provided with a sense of security while using the HMD 101.

Although the reality-space images saved in the above description are ones obtained from the positioning cameras 205, it is to be noted that they are not limited those. Images obtained from the display image generation cameras 201 may be saved. In a case of saving images obtained from the positioning cameras 205, reduction in data volume is prioritized over image quality, which makes long-duration recording possible. By contrast, in a case of saving images obtained from the display image generation cameras 201, high image quality can be prioritized over data volume.

Also, although the flowchart described above has the step for determining whether the HMD 101 is being worn after the step of generating display images and the step of displaying the display images, the present disclosure is not limited to this order. For example, the step for determining whether the HMD 101 is being worn may be provided before the step of generating display images and the step of displaying the display images.

### Second Embodiment

An image processing apparatus 102A of a second embodiment makes it known to the surroundings of a user that reality images are being saved.

### (Configuration of the HMD System)

The system configuration and hardware configuration of the HMD system of the second embodiment are similar to those in the first embodiment and are therefore not described here.

### (Functional Configuration of the Image Processing Apparatus)

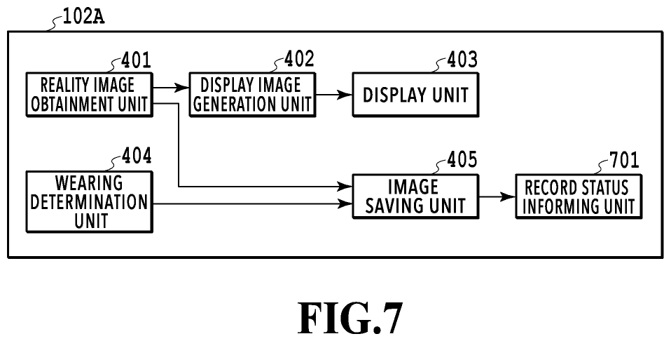

FIG. 7 is a diagram showing a functional configuration of the image processing apparatus 102A in the second embodiment. The image processing apparatus 102A has the reality image obtainment unit 401, the display image generation unit 402, the display unit 403, the wearing determination unit 404, the image saving unit 405, and a record status informing unit 701.

The reality image obtainment unit 401, the display image generation unit 402, the display unit 403, the wearing determination unit 404, and the image saving unit 405 are the same as those in the first embodiment and are therefore not described here. In the following description, they are denoted by the same reference numerals.

The second embodiment differs from the first embodiment in that the image processing apparatus 102A has the record status informing unit 701. The record status informing unit 701 informs the surroundings of a user that the image saving unit 405 is executing the image saving processing.

### (Processing Executed by the Image Processing Apparatus)

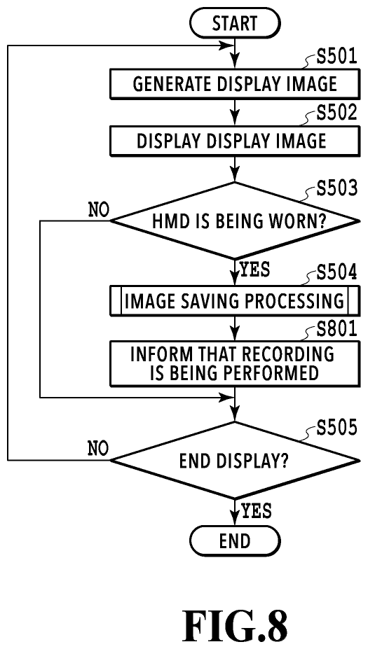

FIG. 8 is a flowchart showing the flow of processing in the second embodiment. With reference to FIG. 8, the flow of the processing in the second embodiment executed by the image processing apparatus 102A is described. Note that S501 to S505 in the flowchart shown in FIG. 8 are the same as S501 to S505 (FIG. 5) in the first embodiment. In comparison to the flowchart in FIG. 5, the flowchart in FIG. 8 additionally has processing in S801. S801 is executed while the image saving processing, which is started in S504, is being executed.

In S801, the record status informing unit 701 informs the surroundings of the user that the image saving processing is being executed. Examples of the informing method include blinking an LED installed at the HMD 101. Note that the informing method is not limited to this. For example, the informing may be achieved by outputting a sound or a voice message from the speaker.

In S505, the image saving unit 405 determines whether to end the display processing. If it is determined not to end the display processing, the processing proceeds back to S501. If it is determined to end the display processing, the processing in this flowchart ends.

As thus described, with a user wearing the HMD 101, it is possible to let people around the user to know that reality images of the surroundings of the user are being recorded. This enables the user to feel more secure while viewing a VR. Also, by letting the surrounding people know that images of the surroundings are being recorded, tamper or crime prevention can be expected.

### Modification

Although the second embodiment shows an example of informing the people around the user, it is also possible to notify the user themselves that reality images have been saved. For example, if it is determined in S505 to end the display processing, the CPU 301 of the image processing apparatus 102A notifies the user that reality images have been saved. Examples of the notification method include displaying text or an icon on the displays of the HMD 101 or outputting a voice announcement, indicating that reality images have been saved. Also, the timing of the notification about recording of reality images of the surroundings is not limited to after the display processing ends, but may be before the display processing starts. Also, an icon indicating recording of reality images of the surroundings may be displayed on a display screen during the execution of the display processing. This enables the user to feel more secure while wearing the HMD 101.

### Third Embodiment

An image processing apparatus 102B of a third embodiment further includes a switching unit 902 that switches whether the image saving unit 405 saves reality images. In the third embodiment, based on content displayed by the HMD 101, the switching unit 902 switches whether the image saving unit 405 saves reality images.

### (Configuration of the HMD System)

The system configuration and hardware configuration of the HMD system of the third embodiment are the same as those of the first embodiment and are therefore not described here.

### (Functional Configuration of the Image Processing Apparatus)

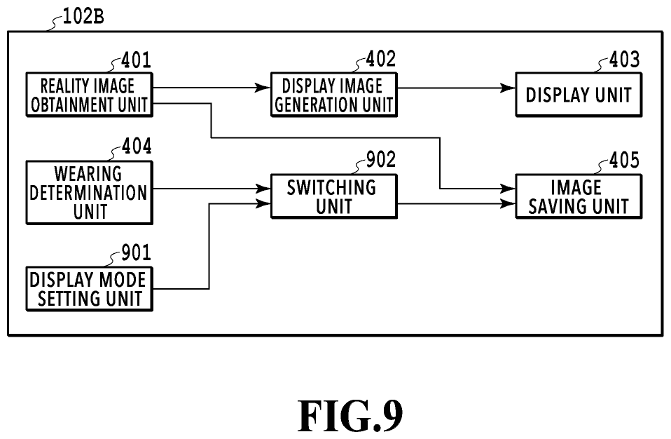

FIG. 9 is a diagram showing a functional configuration of the image processing apparatus 102B in the third embodiment. The image processing apparatus 102B has the reality image obtainment unit 401, the display image generation unit 402, the display unit 403, the wearing determination unit 404, the image saving unit 405, a display mode setting unit 901, and the switching unit 902.

The reality image obtainment unit 401, the display image generation unit 402, the display unit 403, the wearing determination unit 404, and the image saving unit 405 are the same as those in the first embodiment and are therefore not described here and are denoted by the same reference numerals as those used in the first embodiment. The third embodiment differs from the first embodiment in having the display mode setting unit 901 and the switching unit 902.

The display mode setting unit 901 sets a display mode, which indicates the type of images to be displayed by the HMD 101. Display modes include a VR mode and a see-through mode. The VR mode is a mode where a VR video is displayed. In the VR mode, reality images obtained by the reality image obtainment unit 401 are not included in display content. Thus, the user cannot see the situation of their surroundings. By contrast, the see-through mode is a mode where an MR video or an AR video described above is displayed. In the see-through mode, reality images obtained by the reality image obtainment unit 401 are reflected in display content in real time. Thus, it can be said that in the see-through mode, a user is in a state of being able to see the situation of their surroundings. The mode in which the image processing apparatus 102B operates can be specified by user operation.

The switching unit 902 switches whether to save reality images obtained by the reality image obtainment unit 401. Specifically, the switching unit 902 makes a switch so that the image saving unit 405 will not save reality images in the following situation: the wearing determination unit 404 detects wearing of the HMD 101, and content displayed by the HMD 101 includes reality images obtained by the reality image obtainment unit 401. Also, the switching unit 902 makes a switch so that the image saving unit 405 will save reality images in the following case: wearing of the HMD 101 is detected, and content displayed by the HMD does not include reality images obtained by the reality image obtainment unit 401. In a case where a displayed mode is settable like in the present embodiment, the switching unit 902 switches whether the image saving unit 405 saves reality images according to the display mode set by the display mode setting unit 901.

In a case where the wearing determination unit 404 determines that the HMD 101 is being worn by the user and a display mode other than the see-through mode is set by the display mode setting unit 901, the switching unit 902 instructs the image saving unit 405 to save reality images. In the example in the present embodiment, in a case where the VR mode is set, the switching unit 902 instructs the image saving unit 405 to save reality images. By contrast, in a case where the wearing determination unit 404 determines that the HMD 101 is not being worn by the user or the see-through mode is set by the display mode setting unit 901, the switching unit 902 instructs the image saving unit 405 not to save reality images.

In this way, reality images are not saved while the user can see the situation of their surroundings through the content being displayed, whereas reality images are saved while the user cannot see the situation of their surroundings through the content being displayed. This enables reduction in the volume of data recorded.

### (Processing Executed by the Image Processing Apparatus)

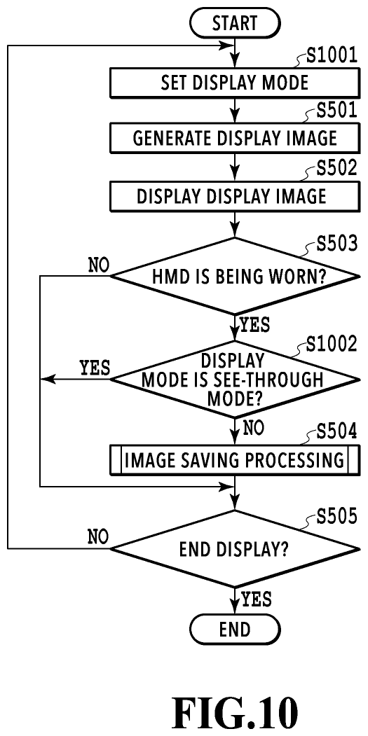

FIG. 10 is a flowchart showing the flow of processing in the third embodiment. With reference to FIG. 10, the flow of the processing in the third embodiment executed by the image processing apparatus 102B is described. Note that S501 to S505 in the flowchart shown in FIG. 10 are the same as S501 to S505 in the processing in the first embodiment. In comparison to the flowchart in FIG. 5, the flowchart in FIG. 10 additionally has S1001 and S1002.

In S1001, the display mode setting unit 901 sets a display mode. This setting is executed based on user operation. The image processing apparatus 102B may display a user interface (UI) screen for setting a display mode on the displays 203 or the HMD 101 or another display device connected to the image processing apparatus 102B and receive an input on the UI screen from the input device 311. As described above, examples of the display mode include the VR mode and the see-through mode.

In S501, the display image generation unit 402 generates display images according to the display mode. Specifically, in the see-through mode, an MR or AR video where a reality image and a virtual image are superimposed is generated, and in the VR mode, a video including no reality images, such as computer graphics or a movie, is generated.

In S502, the display unit 403 displays the left-eye display image and the right-eye display image generated in S501 respectively on the display 203a for the left eye and the display 203b for the right eye. In S503, the wearing determination unit 404 determines whether the HMD 101 is being worn by the user. This determination is the same as that in the first embodiment. If it is determined that the HMD 101 is being worn, the processing proceeds to S1002. If not, the processing skips S1002 and S504 and proceeds to S505.

In S1002, the switching unit 902 checks the display mode set in S1001. If the display mode is not the see-through mode, the processing proceeds to S504, where the image saving processing is executed. If the display mode is the see-through mode, the processing skips S504 and proceeds to S505.

S504 and S505 are the same as those in the first embodiment. Specifically, in S504, the image saving unit 405 performs the image saving processing, and in S505, the image saving unit 405 determines whether to end the display processing. If it is determined not to end the display processing, the processing proceeds back to S501, and if it is determined to end the display processing, the processing in this flowchart ends.

As thus described, according to the processing in the third embodiment, images of the reality space around the user can be saved (recorded) in a case where a mode other than the see-through mode is set with the user wearing the HMD 101 on their head. Thus, while the user is viewing a video including no reality image, such as a VR video, images of the reality space around the user can be saved (recorded). Because the HMD 101 displays reality images in the see-through mode, the user can check the real world around them with no need to record the images. Saving no reality images in the see-through mode enables reduction in the volume of data recorded.

### Fourth Embodiment

An image processing apparatus 102C of a fourth embodiment further includes a switching unit 1102 that switches whether the image saving unit 405 saves reality images. In the fourth embodiment, the switching unit 1102 switches whether to save reality images based on the position and posture of the user wearing the HMD 101.

### (Configuration of the HMD System)

The system configuration and hardware configuration of the HMD system of the fourth embodiment are the same as those of the first embodiment and are therefore not described here.

### (Functional Configuration of the Image Processing Apparatus)

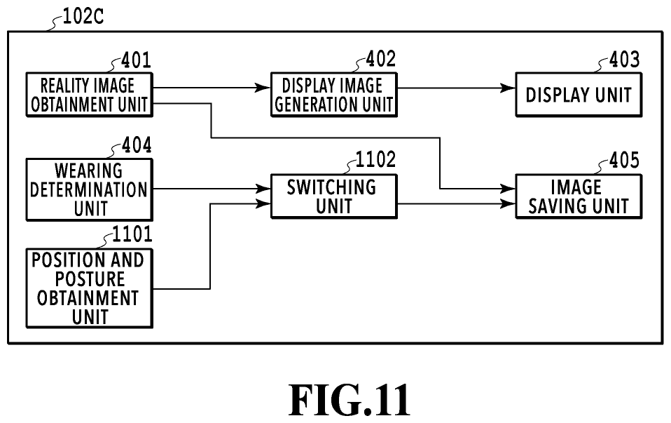

FIG. 11 is a diagram showing a functional configuration of the image processing apparatus 102C in the fourth embodiment. The image processing apparatus 102C has the reality image obtainment unit 401, the display image generation unit 402, the display unit 403, the wearing determination unit 404, the image saving unit 405, a position and posture obtainment unit 1101, and the switching unit 1102.

The reality image obtainment unit 401, the display image generation unit 402, the display unit 403, the wearing determination unit 404, and the image saving unit 405 are the same as those in the first embodiment and are therefore not described here and denoted by the same reference numerals as those used in the first embodiment. The fourth embodiment differs from the first embodiment in having the position and posture obtainment unit 1101 and the switching unit 1102.

The position and posture obtainment unit 1101 obtains information on the position and posture of the HMD 101 worn by the user. The position and posture of the HMD 101 can be estimated through, for example, self-position estimation processing using the visual SLAM technique. The visual SLAM technique is a technique in which information (three-dimensional information) on the surroundings is obtained from image data obtained by a camera or an image sensor, and self-position estimation and environment map creation are performed simultaneously based on the three-dimensional information on the surroundings. Note that the method used by the position and posture obtainment unit 1101 to obtain information on the position and posture of the HMD 101 is not limited to the visual SLAM technique, and the position and posture obtainment unit 1101 may use, for example, the lidar SLAM technique, which obtains information (three-dimensional information) on the surroundings using a distance sensor such as lidar. As described earlier, information on the position and posture of the HMD 101 is expressed using, example, 6DoF.

The switching unit 1102 switches whether the image saving unit 405 saves reality images, based on a result of determination by the wearing determination unit 404 and the position and posture information on the HMD 101 obtained by the position and posture obtainment unit 1101. Specifically, in a case where the wearing determination unit 404 determines that the HMD 101 is being worn by the user and the position and posture information on the HMD 101 obtained by the position and posture obtainment unit 1101 substantially coincides with a predetermined reference position and posture, the switching unit 1102 makes a switch so that the image saving unit 405 will save reality images. The position and posture information substantially coinciding with a predetermined reference position and posture encompasses not only a case where the position and posture indicated by the position and posture information completely coincides with the predetermined reference position and posture, but also a case where the position and posture indicated by the position and posture information is within a predetermined range from the predetermined reference position and posture.

By contrast, in a case where the wearing determination unit 404 determines that the HMD 101 is not being worn by the user or the position and posture information on the HMD 101 obtained by the position and posture obtainment unit 1101 is not within the predetermined range from the predetermined reference position and posture, the switching unit 1102 makes a switch so that the image saving unit 405 will not save reality images.

### (Processing Executed by the Image Processing Apparatus 102C)

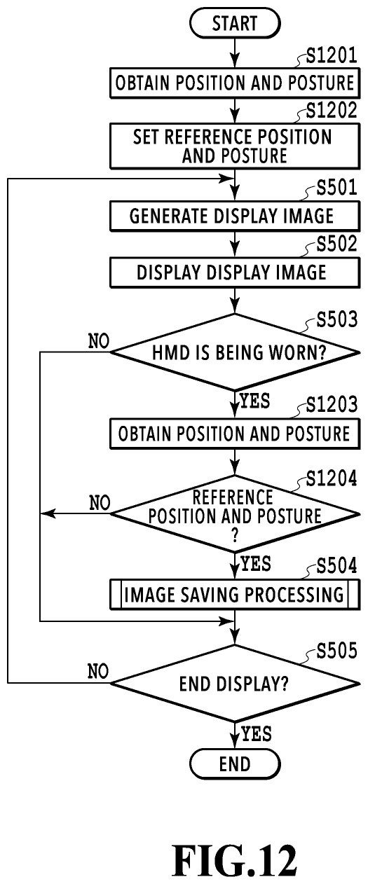

FIG. 12 is a flowchart showing the overall flow of processing in the fourth embodiment. With reference to FIG. 12, the flow of the processing in the fourth embodiment executed by the image processing apparatus 102C is described. Note that S501 to S505 in the flowchart shown in FIG. 12 are the same as S501 to S505 in the processing in the first embodiment. In comparison to the flowchart in FIG. 5, the flowchart in FIG. 12 additionally has S1201, S1202, S1203, and S1204.

Once the flowchart in FIG. 12 starts, first in S1201, the position and posture obtainment unit 1101 determines information indicating the position and posture of the HMD 101. In a case of using the visual SLAM technique described above, the position and posture obtainment unit 1101 obtains reality images from the positioning cameras 205 of the HMD 101, estimates distances to a plurality of particular objects (feature points), and uses that information to perform relative self-position estimation. For example, with stereo cameras, the distances to the feature points can be estimated using parallax information. Then, because the distances to the feature points change as the HMD moves, the differences are compared with the plurality of feature points to estimate the relative positions of the objects. Note that the position and posture information on the HMD 101 may be obtained not only by using the visual SLAM technique, but also by estimation accomplished by any other methods.

In S1202, the position and posture obtainment unit 1101 sets the position and posture obtained in S1201 as a reference position and posture.

Next, the CPU 301 of the image processing apparatus 102C executes the processing in S501 to S503. Specifically, in S501, the display image generation unit 402 generates display images. In S502, the display unit 403 displays the left-eye display image and the right-eye display image generated in S501 respectively on the left-eye display 203a and the right-eye display 203b of the HMD 101. In S503, the wearing determination unit 404 determines whether the user is wearing the HMD 101. The determination method is the same as that used in the first embodiment. If it is determined that the user is wearing the HMD 101, the processing proceeds to S1203. If not, the processing skips S1203, S1204, and S504 and proceeds to S505.

In S1203, the position and posture obtainment unit 1101 obtains the current position and posture of the HMD 101. The position and posture is obtained using the same method as in S1201.

In S1204, the image saving unit 405 determines whether the position and posture obtained in S1203 coincides with the reference position and posture set in S1202. Note that even if the position and posture obtained in S1203 does not completely coincide with the reference position and posture, it may be determined that they coincide as long as the deviation is small. In this case, a margin indicating of the deviation range is defined in advance. If the position and posture obtained in S1203 is within the deviation range of the reference position and posture set in S1202, the image saving unit 405 determines that the position and posture obtained in S1203 coincides with the reference position and posture.

If the position and posture obtained in S1203 is within the predetermined range from the reference position and posture set in S1202, the processing proceeds to S504, where the image saving processing is executed. If the position and posture obtained in S1203 is not within the predetermined range from the reference position and posture set in S1202, the processing skips S504 and proceeds to S505.

Processing in S504 and S505 is the same as that in the first embodiment. Specifically, in S504, the image saving unit 405 performs the image saving processing, and in S505, the image saving unit 405 determines whether to end the display processing. If it is determined not to end the display processing, the processing proceeds back to S501, and if it is determined to end the display processing, the processing in this flowchart ends.

In the image saving processing in S504 in the fourth embodiment, the position and posture of the user wearing the HMD 101 at the time of starting using the HMD 101 (generation and display of display images) is set as the reference position and posture. Then, the image saving unit 405 saves the reality images of the surroundings of the user if the position and posture of the user coincides with the reference position and posture (+ a margin). This enables the situation of the real world to be recorded focusing on a given region toward which the user is facing at the time of starting the processing, and the recording can be checked later. For example, in a case where a baggage is placed in front of the user, the user assumes, at the start of the processing, the position and posture at which they can see the baggage, so that images in the region including the baggage can be recorded during use of the HMD as well. This consequently makes the user feel more secure during use of the HMD. Also, because the reality images saved have almost no change in the position and posture of the user, the images have less blurring. This prevents screen sickness which a user may otherwise experience in checking the saved situation of the reality world later.

### Modification 1 of the Fourth Embodiment

Although the fourth embodiment shows an example where the position and posture of the user at the time of wearing the HMD 101 and starting using the HMD 101 (generation and display of display images) is set as the reference position and posture, the present disclosure is not limited to this. For example, before the processing in FIG. 12 is started, the CPU 301 of the image processing apparatus 102C may display a UI screen including reality images on the displays 203 of the HMD 101 to instruct the user to face the region that the user want to focus on. In that case, the CPU 301 may receive a position and posture determined (specified) by the user as instructed by the UI screen in S1201 and set that position and posture as the reference position and posture.

### Modification 2 of the Fourth Embodiment

The method for specifying the reference position and posture is not limited to the above. For example, the reference position and posture may be specified and received from a user through an input device such as a keyboard or a mouse. In that case, the CPU 301 of the image processing apparatus 102C displays reality images that the HMD 101 is obtaining on the displays 203 in real time and receive, on the screen, specification of the region that the user want to focus on.

### Fifth Embodiment

The first to fourth embodiments show examples where the image processing apparatuses 102 to 102C save obtained reality images without processing them, but the present disclosure is not limited to this. In a fifth embodiment, an image processing apparatus 102D may generate wide-angle-of-view images based on reality images and save the wide-angle-of-view images. A description of the wide-angle-of-view image will be given later.

### (Configuration of the HMD System)

The system configuration and hardware configuration of the HMD system of the fifth embodiment are the same as those of the first embodiment and are therefore not described here.

### (Functional Configuration of the Image Processing Apparatus)

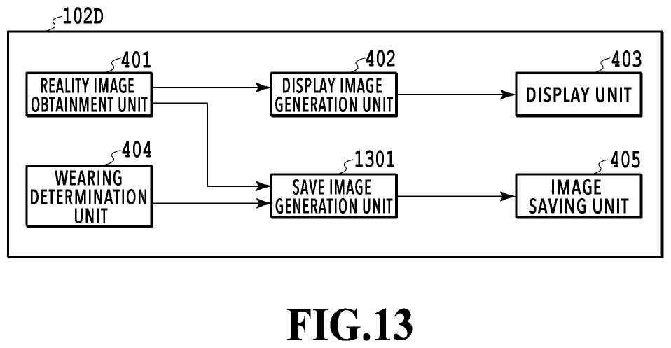

FIG. 13 is a diagram showing a functional configuration of the image processing apparatus 102D in the fifth embodiment. The image processing apparatus 102D has the reality image obtainment unit 401, the display image generation unit 402, the display unit 403, the wearing determination unit 404, the image saving unit 405, and a save image generation unit 1301.

The reality image obtainment unit 401, the display image generation unit 402, the display unit 403, the wearing determination unit 404, and the image saving unit 405 are the same as those in the first embodiment and are therefore not described here and denoted by the same reference numerals as those used in the first embodiment.

Based on reality images obtained by the reality image obtainment unit 401, the save image generation unit 1301 generates save images to be saved by the image saving unit 405. In the fifth embodiment, the save image generation unit 1301 generates wide-angle-of-view images.

### (Processing Executed by the Image Processing Apparatus 102D)

The overall flow of the processing executed by the image processing apparatus 102D of the fifth embodiment is the same as that of the processing in the first embodiment shown in FIG. 5 and is therefore not described here. The following describes the image saving processing in S504, which is performed differently from the first embodiment.

### Details of the Image Saving Processing in the Fifth Embodiment

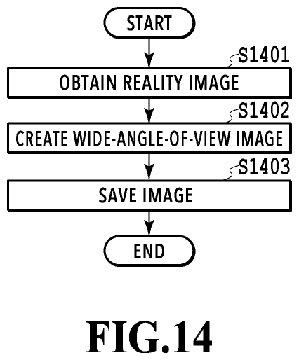

FIG. 14 is a flowchart showing the flow of the image saving processing in the fifth embodiment. With reference to FIG. 14, the flow of the image saving processing in the fifth embodiment executed by the image processing apparatus 102D is described.

In S1401, the reality image obtainment unit 401 obtains reality images from the left and right positioning cameras 205a, 205b connected to the HMD 101. Note that the images obtained here are not limited to the images captured by the positioning cameras 205a, 205b. For example, in a case where the RGB cameras 201a, 201b for generating display images or other cameras are connected, reality images captured by those plurality of cameras may be obtained.

In S1402, the save image generation unit 1301 generates a wide-angle-of-view image using the plurality of reality images obtained in S1401. A wide-angle-of-view image is an image with a wider angle of view than the image capture range (angle of view) of a single camera capturing reality images. Disposed away from each other by a predetermined distance, the positioning cameras 205a, 205b have image capture ranges partly overlapping with each other and partly different from each other. For example, the stitching technique can be used as the method for generating a wide-angle-of-view image. In the stitching technique, the CPU 301 (or the GPU 302) extracts feature points from the respective plurality of reality images, performs matching of the plurality of reality images based on the feature points, and combines the images based on the matching results. As a result, an image where the images obtained from the respective positioning cameras 205a, 205b are joined with their feature points coinciding with each other can be obtained as a wide-angle-of-view image. Note that the method for generating a wide-angle-of-view image is not limited to the stitching technique, and any given method may be used.

In S1403, the image saving unit 405 saves the wide-angle-of-view image generated in S1402 to the HDD 305.

As thus described, according to the image processing apparatus 102D of the fifth embodiment, an image with a wider angle of view than a single one of the cameras provided to the HMD 101, e.g., the cameras 205 for obtaining positional information, can be generated and saved. This enables a user to later check the situation of the real world in a wider range than in the first embodiment. This makes the user feel more secure while viewing a VR. Note that the images used for generating a wide-angle-of-view image are not limited to the reality images obtained by the cameras 205a, 205b for obtaining positional information. For example, a plurality of reality images obtained from the cameras 201a, 201b for generating display images may be used. In that case, an image with a wider angle of view than that of a single one of the display image generation cameras 201 is generated. Alternatively, in a case where there are cameras at the rear and left and right sides of the user, a plurality of images obtained from these cameras may be combined to generate an image with a wider angle of view than that of a single one of those cameras.

### Sixth Embodiment

In a video such as an MR or AR video where a virtual image (a CG image) and a reality image are superimposed over each other, a region in the reality image which is behind the virtual object (CG object) is hidden by the virtual object. Then, even while a video is displayed in the see-through mode, the user may be unable to see part of the reality image hidden by the virtual object. Thus, in a sixth embodiment, from a display image, an image processing apparatus 102E saves an image of a region in a reality image hidden by a virtual object.

### (Configuration of the HMD System)

The system configuration and hardware configuration of the HMD system of the sixth embodiment are the same as those of the first embodiment and are therefore not described here.

### (Functional Configuration of the Image Processing Apparatus)

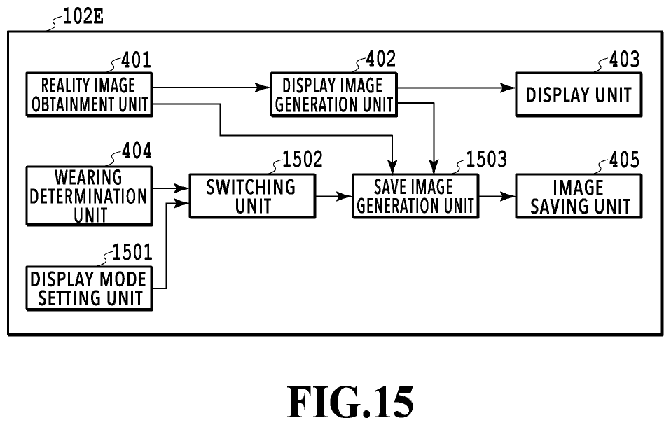

FIG. 15 is a diagram showing a functional configuration of the image processing apparatus 102E in the sixth embodiment. The image processing apparatus 102E has the reality image obtainment unit 401, the display image generation unit 402, the display unit 403, the wearing determination unit 404, the image saving unit 405, a display mode setting unit 1501, a switching unit 1502, and a save image generation unit 1503.

The reality image obtainment unit 401, the display image generation unit 402, the display unit 403, the wearing determination unit 404, and the image saving unit 405 are the same as those in the first embodiment and are therefore not described here and denoted by the same reference numerals as those used in the first embodiment. The sixth embodiment differs from the first embodiment in having the display mode setting unit 1501, the switching unit 1502, and the save image generation unit 1503.

The display mode setting unit 1501 sets a display mode as the type of images displayed on the HMD 101. In the present embodiment, like in the third embodiment, either the VR mode or the see-though mode is settable by user operation.

The switching unit 1502 switches the image saving processing executed by the image saving unit 405 according to the result of determination by the wearing determination unit 404 and the display mode set by the display mode setting unit 1501. Note that in the third embodiment described above, images are not saved in the display mode where reality images are included in content displayed (the see-through mode). Thus, in a case where the see-through mode is set, images are not saved because displayed content includes reality images. In the sixth embodiment, even if displayed content includes reality images, in a case where there is a region hidden by CG, a reality image of that region is saved.

Specifically, in a case where the wearing determination unit 404 determines that the HMD 101 is being worn by the user and the see-through mode is set by the display mode setting unit 1501, the switching unit 1502 makes a switch to execute second image saving processing. The second image saving processing is different from the image saving processing described in the first embodiment (hereinafter referred to as first image saving processing) in that the image saving unit 405 saves images to be saved generated by the save image generation unit 1503. Note that in a case where the wearing determination unit 404 determines that the HMD 101 is being worn by a user and a display mode other than the see-through mode (i.e., the VR mode) is set by the display mode setting unit 1501, the image saving unit 405 executes the first image saving processing.

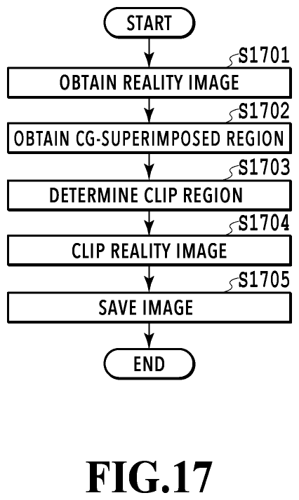

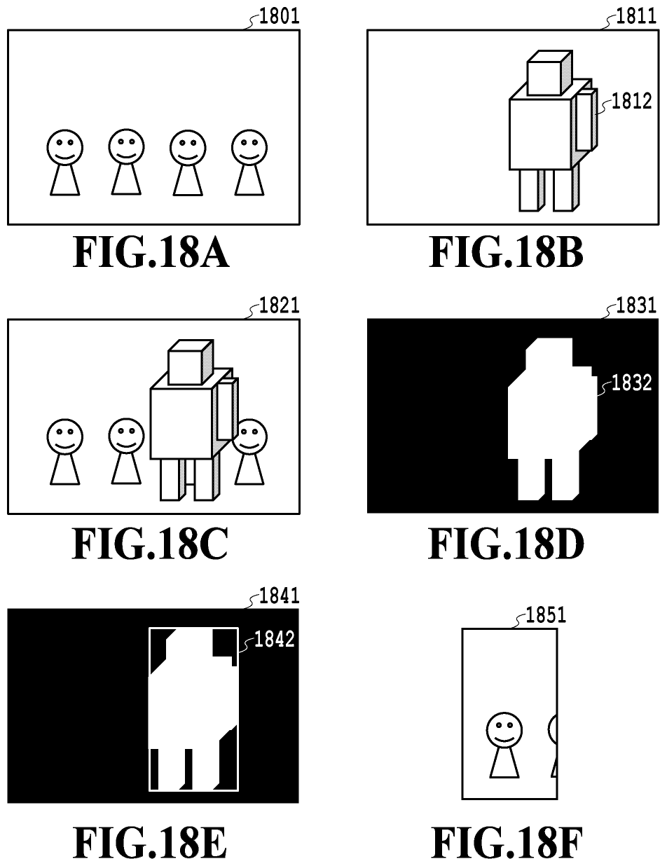

In the second image saving processing, the save image generation unit 1503 generates an image to be saved. The image to be saved is, in a reality image included in a display image, an image including a region hidden by CG. A description of processing for generating an image to be saved will be given later (FIGS. 17 and 18).

### (Processing Executed by the Image Processing Apparatus 102E)

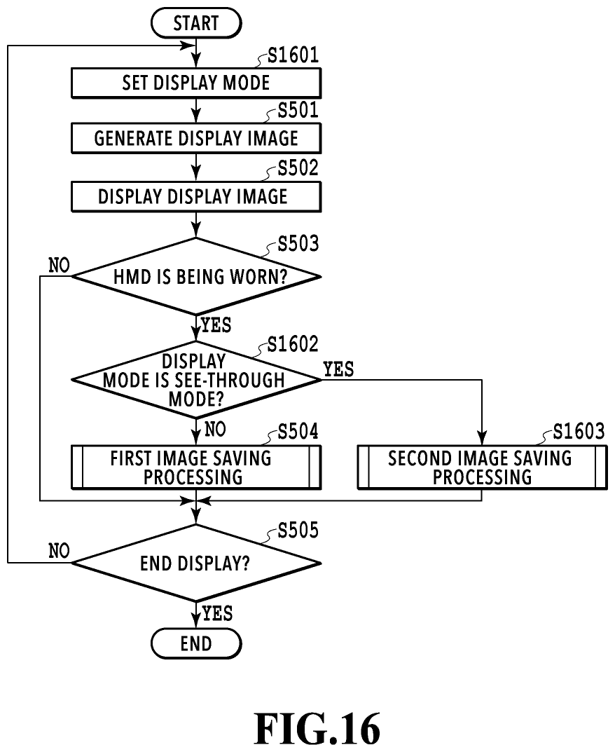

FIG. 16 is a flowchart showing the overall flow of processing in the sixth embodiment. With reference to FIG. 16, the flow of the processing in the sixth embodiment executed by the image processing apparatus 102E is described. Note that S501 to S505 in the flowchart shown in FIG. 16 are the same as S501 to S505 in the processing in the first embodiment. In comparison to the flowchart in FIG. 5, the flowchart in FIG. 16 additionally has S1601, S1602, and S1603.

In S1601, the display mode setting unit 1501 sets a display mode. This processing is the same as S1001 in the third embodiment and is executed based on user operation. Either the VR mode or the see-through mode is set as the display mode.

Next, in S501, the display image generation unit 402 generates display images according to the display mode. In S502, the display unit 403 displays the left-eye display image and the right-eye display image generated in S501 respectively on the left-eye display 203a and the right-eye display 203b of the HMD 101. In S503, the wearing determination unit 404 determines whether the user is wearing the HMD 101. This determination is performed similarly to the first embodiment. If it is determined that the user is wearing the HMD 101, the processing proceeds to S1602. If not, the processing proceeds to S505.

In S1602, the image saving unit 405 determines the display mode set in S1601. If the display mode is set to a mode other than the see-through mode, i.e., the VR mode, the processing proceeds to S504, and if the display mode is set to the see-through mode, the processing proceeds to S1603.

In S504, the image saving unit 405 performs the first image saving processing, which is image saving processing similar to that in the first embodiment (FIG. 6).

In S1603, the image saving unit 405 executes the second image saving processing. The second image saving processing is performed differently from the first image saving processing. Details of the second image saving processing will be described later.

While the first image saving processing in S504 or the second image saving processing in S1603 is being executed, in S505 the image saving unit 405 determines whether to end the display processing. If it is determined not to end the display processing, the processing proceeds back to S501, and if it is determined to end the display processing, the processing in this flowchart ends.

### (Details of the Second Image Saving Processing)

FIG. 17 is a flowchart showing the flow of the second image saving processing executed in S1603 in FIG. 16. FIGS. 18A to 18F are diagrams showing an overview of the second image saving processing. With reference to FIG. 17 and FIGS. 18A to 18F, the flow of the second image saving processing executed by the image processing apparatus 102E in the sixth embodiment is described.

In S1701, the reality image obtainment unit 401 obtains reality images from the cameras of the HMD 101. Note that in the sixth embodiment, the reality image obtainment unit 401 obtains reality images from the display image generation cameras 201. A reality image 1801 like the one shown in FIG. 18A is obtained.

In S1702, the save image generation unit 1503 obtains a CG-superimposed region from the display image generation unit 402. This is described with reference to FIGS. 18A to 18F. It is assumed here that the display image generation unit 402 renders a CG image 1811 shown in FIG. 18B, superimposes the CG image 1811 on the reality image 1801 shown in FIG. 18A, and thereby generates a display image 1821 shown in FIG. 18C. A technique for obtaining a superimposition image where two images are superimposed is alpha blending. Alpha blending is processing that combines two images using a coefficient α (where α is a real number which is 0 or greater and 1 or smaller) and Formula (1) below:

$$dst ( x , y ) = src 1 ( x , y ) \times α + src 2 ( x , y ) \times ( 1 - α ) . \qquad ( 1 )$$

This Formula (1) means that pixel values of two input images src1, src2 are blended at a ratio of α:(1−α) to generate pixel values of an output image dst. To perform addition, the two input images are in the same size. The reality image 1801 in FIG. 18A corresponds to src2, the CG image 1811 in FIG. 18B corresponds to src1, and the display image 1821 in FIG. 18C corresponds to dst. The value of α can be determined for every pixel. The display image 1821 is generated with α=1 for pixels of the CG image 1811 where a virtual object 1812 exists and α=0 for the other pixels of the CG image 1811. For example, the pixels of the CG image 1811 where the virtual object 1812 exists can be determined as follows: a depth image corresponding to the CG image 1811 is obtained, and the depth image is binarized using the upper limit value of the depth of the rendering range of the virtual object 1812. As shown in FIG. 18D, a region 1832 shown in white is a region where the virtual object 1812 exists, and is blended using α=1. A region shown in black is a region where the virtual object 1812 does not exist, and is blended using α=0.

The region where the virtual object 1812 is superimposed on (to be the foreground of) the reality image 1801 as seen from the user is the region 1832 shown in white in FIG. 18D (the region with α=1). Thus, in FIG. 18D, the region shown in white is a region where the virtual object 1812 and the reality image overlap (a superimposition region), and the region shown in black is a region where only the reality image is displayed. A region where the virtual object 1812 is superimposed on (to be the foreground of) the reality image 1801 is hereafter referred to as a superimposition region.

In S1703, the save image generation unit 1503 determines a region clipped out from the reality image 1801. The region clipped here is hereinafter referred to as a clip region. The clip region is determined so as to include at least the superimposition region 1832 obtained in S1702. For example, the save image generation unit 1503 sets a minimum rectangular frame 1842 circumscribing the superimposition region 1832. Taking the images in FIGS. 18A to 18F as an example, a part of an image 1841 corresponding to the display image 1821 which is inside the rectangular frame 1842 represents a clip region. Note that the method for determining the clip region is not limited to this. The frame does not need to be rectangular as long as at least the superimposition region 1832 is included, and may be polygonal or circular or may be the superimposition region 1832 itself.

In S1704, based on the clip region determined in S1703, the save image generation unit 1503 clips the clip region out from the reality image obtained in S1701. Taking the images in FIGS. 18A to 18F as an example, a clip region corresponding to the rectangular frame 1842 shown in FIG. 18D is clipped out from the reality image 1801, generating a save image 1851 like the one shown in FIG. 18F.

In S1705, the image saving unit 405 saves the save image 1851 clipped out in S1704 to the HDD 305. Although the example in FIGS. 18A to 18F shows one frame of a display image formed by a plurality of frames, it is to be noted that the save image generation unit 1503 similarly generates save images for the other frames as well.

As thus described, in the sixth embodiment, in a mode where a superimposition image where a reality image and CG (a virtual object) are superimposed is displayed on the HMD 101, the save image generation unit 1503 clips out a reality image which is the background of the CG (virtual object) and saves the reality image. Specifically, the save image generation unit 1503 identifies, on a superimposed image, a superimposed region where a virtual object is superimposed over a reality image as its foreground, clips out a clip region corresponding to the identified superimposition region from the reality image, and generates a save image. The image saving unit 405 saves the save image generated by the save image generation unit 1503 to the HDD 305.

In this way, the reality image of the region which is hidden behind the CG (virtual object) and unseeable from the user who is viewing an MR or AR video using the HMD 101 can be saved. Thus, the user can later check the situation of the real world which was hidden by the CG (virtual object) and unseeable from the user. This makes the user feel more secure while using the HMD 101. Also, because the clipped save image is smaller in size than the reality image captured by the camera, the volume of data saved can be reduced.

Although the save image generation processing described above as an example generates a save image by clipping out a superimposition region from a reality image obtained from the display image generation camera 201, the present disclosure is not limited to this example. The save image generation processing may generate a save image by clipping out a region of a reality image corresponding to a clip region determined in S1703 from a reality image obtained from the positioning camera 205 and save the save image.

### Seventh Embodiment

Although the second image saving processing described in the sixth embodiment clips and saves part of an image to reduce the volume of data saved, the volume of data saved may be reduced in the direction of the time axis. In a seventh embodiment, an image processing apparatus 102F saves a reality image in a case where movement is detected in the real world and does not save a reality image in a case where movement is not detected in the real world.

### (Configuration of the HMD System)

The system configuration and hardware configuration of the HMD system of the seventh embodiment are the same as those of the first embodiment and are therefore not described here.

### (Functional Configuration of the Image Processing Apparatus)

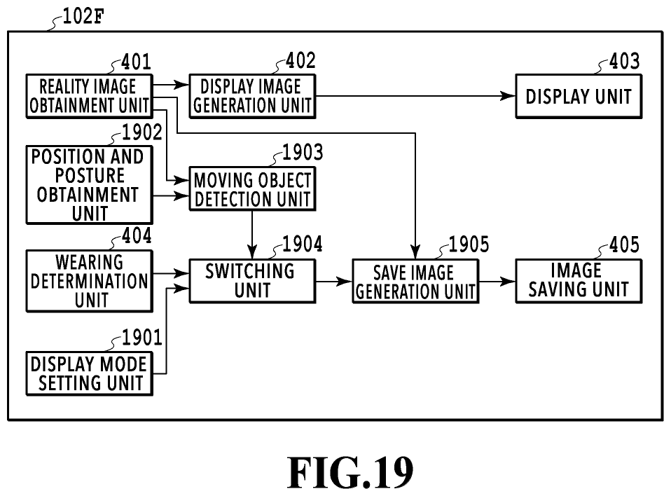

FIG. 19 is a diagram showing a functional configuration of an image processing apparatus 102F in the seventh embodiment. The image processing apparatus 102F has the reality image obtainment unit 401, the display image generation unit 402, the display unit 403, the wearing determination unit 404, the image saving unit 405, a display mode setting unit 1901, a position and posture obtainment unit 1902, a moving object detection unit 1903, a switching unit 1904, and a save image generation unit 1905.

The reality image obtainment unit 401, the display image generation unit 402, the display unit 403, the wearing determination unit 404, and the image saving unit 405 are the same as those in the first embodiment. The display mode setting unit 1901 is the same as that in the third embodiment and sets either the VR mode or the see-through mode as a display mode. The position and posture obtainment unit 1902 is the same as the position and posture obtainment unit 1101 described in the fourth embodiment and obtains information on the position and posture of the HMD 101 worn by the user.

The moving object detection unit 1903 detects moving object from a reality image obtained from the reality image obtainment unit 401. Details of moving object detection will be described later.

The switching unit 1904 determines whether to save reality images based on the result of determination by the wearing determination unit 404, the display mode set by the display mode setting unit 1901, and the result of detection by the moving object detection unit 1903. In the seventh embodiment, the switching unit 1904 instructs the image saving unit 405 to save reality images in a case where: the HMD 101 is being worn by the user, the display mode is set to a mode other than the see-through mode, and moving object is detected in the reality images. Otherwise, the switching unit 1904 does not instruct to save reality images.

The save image generation unit 1905 generates, as a save image, an image clipped out from a reality image to include a region where moving object is detected. A description of save image generation processing will be given later.

### (Processing Executed by the Image Processing Apparatus 102F)

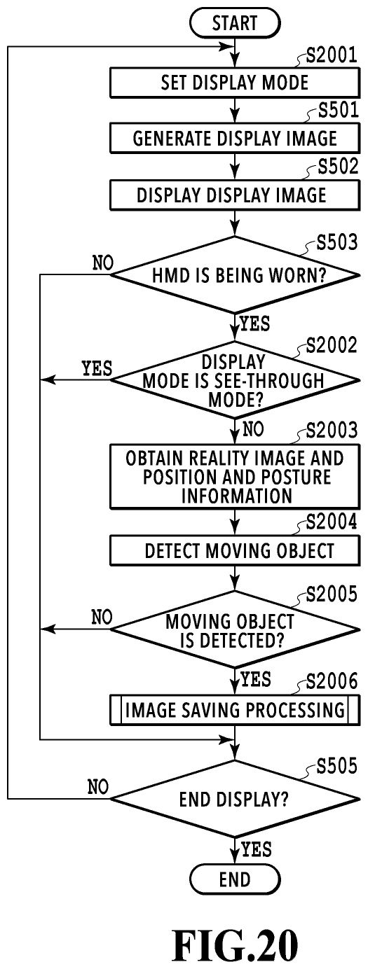

FIG. 20 is a flowchart showing the overall flow of the processing in the seventh embodiment. With reference to FIG. 20, the flow of the processing in the seventh embodiment executed by the image processing apparatus 102F is described. Note that S501 to S503, S504, and S505 in the flowchart shown in FIG. 20 are the same as S501 to S503, S504, and S505 in the processing in the first embodiment. In comparison to the flowchart in FIG. 5, the flowchart in FIG. 20 additionally has S2001, S2002, S2003, S2004, and S2005.

In S2001, the display mode setting unit 1901 sets a display mode. This processing is the same as S1001 in the third embodiment and is executed based on user operation. As described, either the VR mode or the see-through mode is set as the display mode.

In S501, the display image generation unit 402 generates display images according to the display mode. In S502, the display unit 403 displays the left-eye display image and the right-eye display image generated in S501 respectively on the left-eye display 203a and the right-eye display 203b of the HMD 101. In S503, the wearing determination unit 404 determines whether the user is wearing the HMD 101. This determination is performed in the same manner as the first embodiment. If it is determined that the user is wearing the HMD 101, the processing proceeds to S2002. If not, the processing and proceeds to S505.

In S2002, the switching unit 1904 checks the display mode set in S2001. If the display mode is other than the see-through mode (i.e., the VR mode), the processing proceeds to S2003, and if the display mode is the see-through mode, the processing proceeds to S505.

In S2003, the reality image obtainment unit 401 obtains reality images from the cameras of the HMD 101. Also, the position and posture obtainment unit 1902 obtains position and posture information on the HMD 101. In the seventh embodiment, images captured by the positioning cameras 205 are obtained as the reality images. Note that images captured by the display image generation cameras 201 may be obtained as the reality images.

In S2004, the moving object detection unit 1903 detects moving object from the reality images based on the reality images and the position and posture information obtained in S2003. The detection of moving object can be done by, for example, optical flow estimation using the Lucas-Kanade method. The moving object detection unit 1903 detects, as moving object, a region with a different optical flow from its surroundings. Note that the method for the moving object detection is not limited to this.

In S2005, the switching unit 1904 determines whether moving object is detected in the reality images in S2004. If moving object is detected, the processing proceeds to S504, and if moving object is not detected, the processing proceeds to S505.

In S504, the image saving unit 405 executes image saving processing. The image saving processing is the same as the image saving processing in the first embodiment. During the image saving processing in S504, in S505 the image saving unit 405 determines whether to end the display processing. If it is determined not to end the display processing, the processing proceeds back to S501, and if it is determined to end the display processing, the processing in this flowchart ends.

If the display processing is continued, then the moving object detection processing is also continued. Thus, in a period in which the display processing is in execution, reality images are saved while moving object is detected in reality images and are not saved while moving object is not detected. Thus, images thus saved may be intermittent.

As thus described, with the processing in the seventh embodiment, reality images can be saved upon detection of moving object in the real world. This enables the user to later check the situation during a period with any change in the real world while the user was using the HMD and thus feel more secure while viewing a VR video. Because the period in which reality images are saved is restricted to the period in which moving object is detected, the recording time is shortened, thereby reducing the volume of data to be saved, compared to the first embodiment.

### Modification 1 of the Seventh Embodiment

The seventh embodiment described above describes an example where reality images are saved upon detection of moving object in the real world, but the images saved do not have to be the entire reality images. For example, the image saving unit 405 may clip a region where moving object is detected from a reality image and save the clipped region.

### Details of the Image Saving Processing in Modification 1 of the Seventh Embodiment

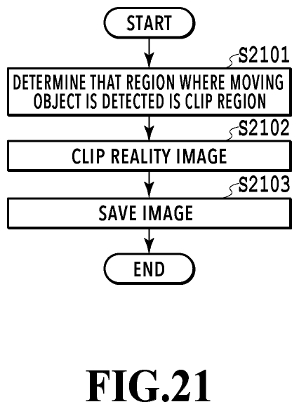

FIG. 21 is a flowchart showing the flow of the image saving processing in Modification 1 of the seventh embodiment. This flowchart is executed in S504 in FIG. 20.

In S2101, the save image generation unit 1905 determines that the region where moving object has been detected as a result of the above-described moving object detection processing in S2004 is a clip region. In S2102, the save image generation unit 1905 clips the clip region determined in S2101 from a reality image. In S2103, the image saving unit 405 saves the image in the clip region clipped in S2102 to the HDD 305 and ends this flowchart.

The above processing in the seventh embodiment can reduce the region to be saved in each frame of an image and thereby reduce the volume of data to be saved.

### Modification 2 of the Seventh Embodiment

While the image processing apparatus 102F in the seventh embodiment saves reality images upon detection of movement (upon detection of moving object) in the reality images obtained, in addition to this, a user may be notified upon detection of movement. For example, upon detection of moving object in reality images in S2004 described above, the image processing apparatus 102F may notify the user by displaying text or an icon indicative of moving object detection on the displays 203 of the HMD 101 or outputting a voice announcement. This enables the user to determine whether to continue or stop using the HMD 101 and can thereby increase safety for the user.

### Modification 3 of the Seventh Embodiment

Although the image processing apparatus 102F in the seventh embodiment performs the moving object detection on the entire reality images obtained, the region to perform moving object detection is not limited to this. For example, a setting of a region to focus on in a reality image may be received from a user in advance, and moving object detection may be performed on the focus region thus received. For example, before the processing in FIG. 20 starts, the CPU 301 of the image processing apparatus 102F may receive specification of a focus region from a user via an input device such as a keyboard or a mouse. In that case, the CPU 301 of the image processing apparatus 102F may display the reality images obtained by the HMD 101 on the display screen in real time to receive, on the screen, the specification of the region on which the user wants to focus. Alternatively, the CPU 301 may display a UI screen and instruct the user to face toward the region on which they want to focus. In that case, the CPU 301 may set, as the focus region, the region captured with the user facing in a given direction as instructed on the UI screen.

Although embodiments of the present disclosure have thus been described with reference to the drawings attached hereto, the present disclosure is not limited to those examples. For example, the images saved by the image saving unit 405 may be in less data volume than the reality images obtained. For example, images saved may be reduced in data in the direction of the time axis by restricting the period to save obtained reality images, as shown in the third, fourth, and seventh embodiments. Alternatively, as shown in the sixth embodiment, data volume may be reduced by saving an image clipped out from a partial region of a reality image obtained. Alternatively, these may be combined to reduce the data volume of images to save in terms of both the direction of the time axis and within the frame. Also, an image having a low frame rate by thinning of frames of a reality image at a predetermined rate or an image having a lower resolution may be saved as the image to be saved. Also, the present disclosure is not limited to the examples described in the embodiments and may combine elements or concepts described in the embodiments. It is apparent to those skilled in the art that various modifications and corrections may be conceived of within the scope of the technical concept disclosed herein, and it is to be understood that they too naturally belong in the technical scope of the present invention.

The present disclosure allows a user to later check images of the real world captured while the user was wearing the HMD and therefore to use the HMD with an easy mind.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments. The scope of the following claims is to be accorded the broadest interpretation so as to encompass all such modifications and equivalent structures and functions.

What is claimed is:

1. An image processing apparatus that controls a display device wearable on a head of a user, the image processing apparatus comprising:
an obtainment unit configured to obtain a reality image which is an image captured of an actual space around the user and
a saving unit configured to save the reality image obtained by the obtainment unit, in a state where the display device is being worn by the user.

2. The image processing apparatus according to claim 1, wherein the reality image obtained by the obtainment unit is captured by an image capture unit that the display device has.

3. The image processing apparatus according to claim 1, further comprising an informing unit configured to inform a surrounding of the user that the saving unit is saving the reality image.

4. The image processing apparatus according to claim 1, further comprising a switching unit configured to switch whether the saving unit saves the reality image.

5. The image processing apparatus according to claim 4, wherein the switching unit switches whether the saving unit saves the reality image based on content displayed on the display device.

6. The image processing apparatus according to claim 4, wherein the switching unit makes a switch not to save the reality image in a case where content displayed on the display device includes the reality image obtained by the obtainment unit.

7. The image processing apparatus according to claim 4, further comprising setting unit configured to set a mode in which the image processing apparatus operates, the mode being either a first mode where an image where the reality image obtained by the obtainment unit and a virtual image are superimposed over each other is displayed on the display device or a second mode where an image not including the reality image is displayed,
wherein, in a case when the setting unit sets the second mode, the switching unit makes a switch to save the reality image.

8. The image processing apparatus according to claim 4, wherein the obtainment unit further obtains position and posture information on the display device in a state where the display device is being worn by the user, and
the switching unit switches whether to save the reality image obtained by the obtainment unit based further on the position and posture information obtained by the obtainment unit.

9. The image processing apparatus according to claim 8, wherein, in a case when a position and posture of the display device indicated by the position and posture information obtained by the obtainment unit is within a predetermined range from a predetermined reference position and posture, the switching unit makes a switch to save the reality image.

10. The image processing apparatus according to claim 9, wherein the reference position and posture is a position and posture of the user at a time of the user starting to use the display device.

11. The image processing apparatus according to claim 4, further comprising a detection unit configured to detect moving object in the reality image obtained by the obtainment unit,
wherein, in a case when the detection unit detects the moving object, the switching unit makes a switch to save the reality image.

12. The image processing apparatus according to claim 1, further comprising a generation unit configured to generate an image to be saved, based on the reality image obtained by the obtainment unit,
wherein the saving unit saves, as the reality image, the image to be saved generated by the generation unit.

13. The image processing apparatus according to claim 12, wherein the image to be saved is an image with less data volume than the reality image obtained by the obtainment unit.

14. The image processing apparatus according to claim 12, wherein the image to be saved is an image with data reduced in a direction of a time axis compared to the reality image obtained by the obtainment unit.

15. The image processing apparatus according to claim 12, wherein the obtainment unit obtains a plurality of the reality images captured by a plurality of image capture units each having a predetermined angle of view as an image capture range, and
the generation unit generates, as the image to be saved, an image having a wider angle of view than the predetermined angle of view based on the plurality of reality images obtained by the obtainment unit.

16. The image processing apparatus according to claim 12, further comprising a detection unit configured to detect moving object in the reality image obtained by the obtainment unit,
wherein the generation unit generates, as the image to be saved, an image clipped to include a region where the moving object is detected in the reality image.

17. The image processing apparatus according to claim 1, wherein the image processing apparatus is configured integrally with the display device.

18. The image processing apparatus according to claim 1, wherein the image processing apparatus is configured separately from the display device and is communicatively connected to the display device via a transmission channel.

19. An image processing method executed by a computer that controls a display device wearable on a head of a user, the method comprising:
obtaining a reality image which is an image captured of an actual space around the user; and
saving the reality image obtained in the obtaining in a state where the display device is being worn by the user.

20. A non-transitory computer readable storage medium storing a program which causes a computer to execute an image processing method, wherein the image processing method is executed by the computer that controls a display device wearable on a head of a user and comprises:
obtaining a reality image which is an image captured of an actual space around the user; and
saving the reality image obtained in the obtaining, in a state where the display device is being worn by the user.
